(19) United States
(12) Patent Application Publication
(10) Pub. No.: US 2026/0260102 A1
(43) Pub. Date: Sep. 3, 2026

(54) METHOD FOR CONVERTING NEURAL NETWORK MODEL FOR MULTIPLE HARDWARE FRAMEWORK

(71) Applicant: ZETIC.ai Inc., Seoul (KR)

(72) Inventor: Yeonseok KIM, Seoul (KR)

(73) Assignee: ZETIC.ai Inc., Seoul (KR)

(21) Appl. No.: 19/332,246

(22) Filed: Sep. 18, 2025

(30) Foreign Application Priority Data
Sep. 19, 2024 (KR) 10-2024-0126638

(51) Int. Cl. G06N 3/0495; G06N 3/10

(52) U.S. Cl. CPC G06N 3/0495; G06N 3/10

(57) ABSTRACT

According to an embodiment of the present disclosure, a method performed by a computing device for converting a neural network model is disclosed. Specifically, according to the present disclosure, the computing device identifies a conversion target neural network model, and generates a plurality of target hardware optimized models based on inputting the conversion target neural network model into a conversion module. The conversion module includes a first conversion sub-module corresponding to a first target hardware and a second conversion sub-module corresponding to a second target hardware. The first conversion sub-module includes a framework related to inference of a neural network of the first target hardware, and the second conversion sub-module includes a framework related to inference of a neural network of the second target hardware.

### CROSS-REFERENCE TO RELATED APPLICATION

This application claims priority under 35 U.S.C. 119 from Korean Patent Application No. 10-2024-0126638 filed on Sep. 19, 2024, the contents of which are incorporated by reference herein.

### TECHNICAL FIELD

The present disclosure relates to a method for converting neural network model for multiple hardware frameworks, and more particularly, to an automated method for converting a general-purpose neural network model into a dedicated model optimized for each of a plurality of target hardware using a conversion module including a plurality of conversion sub-modules.

### BACKGROUND ART

Recently, in the process of rapid development of artificial intelligence technology, interest has increased in technology for performing on-device inference utilizing processors mounted on edge devices, instead of performing inference of neural network models on a central server having enormous computing power. In particular, chip manufacturers have come to mount a Neural Processing Unit (NPU), which is hardware specially designed for inference of neural network models, on a System on Chip (SoC) in addition to existing hardware such as a CPU and a GPU.

However, such hardware included in SoCs produced by SoC manufacturers has proprietary frameworks for using the hardware for each manufacturer. These frameworks are not compatible between manufacturers, and developer interfaces for hardware usage are not provided. Therefore, when application developers utilizing neural network models intend to use specialized hardware, they must learn about the hardware framework of each company and manually generate multiple converted applications by applying each framework, causing a problem in that development period and cost significantly increase.

Accordingly, there is a demand in the art for an automated method for providing a single unified interface in development and deployment stages and generating a model optimized for a framework for specialized hardware of each manufacturer.

Korean Registered Patent No. KR 2586438 discloses a method and apparatus for converting medical images by artificial intelligence.

### DISCLOSURE

### Technical Problem

The present disclosure has been made in an effort to address the above-described background art, and an object of the present disclosure is to provide a method for converting a general-purpose neural network model into a dedicated model optimized for each of a plurality of target hardware using a conversion module including a plurality of conversion sub-modules.

Meanwhile, the technical problems to be solved by the present disclosure are not limited to the technical problems mentioned above, and various technical problems may be included within the scope obvious to those skilled in the art from the following description.

### Technical Solution

According to an embodiment of the present disclosure, a method performed by a computing device for converting a neural network model is disclosed. The method includes identifying a conversion target neural network model; and generating a plurality of target hardware optimized models based on inputting the conversion target neural network model into a conversion module. The conversion module includes a first conversion sub-module corresponding to a first target hardware and a second conversion sub-module corresponding to a second target hardware. The first conversion sub-module includes a framework related to inference of a neural network of the first target hardware, and the second conversion sub-module includes a framework related to inference of a neural network of the second target hardware.

In one embodiment, the generating of the plurality of target hardware optimized models based on inputting the conversion target neural network model into the conversion module may include: generating a general optimized model based on inputting the conversion target neural network model into a pre-processing module; generating a first target hardware optimized model based on inputting the general optimized model into the first conversion sub-module; and generating a second target hardware optimized model based on inputting the general optimized model into the second conversion sub-module.

In one embodiment, the first target hardware optimized model may include a plurality of first target hardware optimized sub-models, and the generating of the first target hardware optimized model based on inputting the general optimized model into the first conversion sub-module may include generating the plurality of first target hardware optimized sub-models based on a predetermined parameter set.

In one embodiment, the predetermined parameter set may include at least one of a parameter related to a type of the target hardware or a parameter related to quantization of the neural network model.

In one embodiment, the method may further include receiving information related to a deployment request for a neural network model from an edge device; and deploying a target hardware optimized model corresponding to the information related to the deployment request to the edge device.

In one embodiment, the information related to the deployment request may include information related to hardware of a user of the edge device and information related to characteristics of the neural network model input by the user.

In one embodiment, the method may further include, after the deploying of the target hardware optimized model corresponding to the information related to the deployment request to the edge device, deploying a general optimized model to the edge device if a target hardware optimized model corresponding to the hardware of the user does not exist.

In one embodiment, the method may further include generating a user interface for using the conversion module in a development environment. The user interface may include a first area for displaying a key of the conversion target neural network model and a second area for displaying a type of the development environment.

According to an embodiment of the present disclosure, a non-transitory computer-readable storage medium storing a computer program that, when executed by a computing device, causes the computing device to perform operations for converting a neural network model is disclosed. The operations include identifying a conversion target neural network model; and generating a plurality of target hardware optimized models based on inputting the conversion target neural network model into a conversion module. The conversion module includes a first conversion sub-module corresponding to a first target hardware and a second conversion sub-module corresponding to a second target hardware. The first conversion sub-module includes a framework related to inference of a neural network of the first target hardware, and the second conversion sub-module includes a framework related to inference of a neural network of the second target hardware.

According to an embodiment of the present disclosure, a computing device for converting a neural network model is disclosed. The computing device includes one or more processors and a memory. The one or more processors are configured to identify a conversion target neural network model; and generate a plurality of target hardware optimized models based on inputting the conversion target neural network model into a conversion module. The conversion module includes a first conversion sub-module corresponding to a first target hardware and a second conversion sub-module corresponding to a second target hardware. The first conversion sub-module includes a framework related to inference of a neural network of the first target hardware, and the second conversion sub-module includes a framework related to inference of a neural network of the second target hardware.

### Advantageous Effects

According to the present disclosure, when generating a specialized neural network model for running on hardware for inference of a neural network such as an NPU, it is possible to generate the specialized neural network model by performing an automated process without needing to separately generate each neural network model according to hardware frameworks of different chip manufacturers. Consequently, the present disclosure produces a significant effect in that development efficiency and deployment efficiency of on-device neural network models are improved.

Meanwhile, the effects of the present disclosure are not limited to the effects mentioned above, and various effects may be included within the scope obvious to those skilled in the art from the following description.

### DESCRIPTION OF DRAWINGS

FIG. 1 is a block diagram of a computing device for converting a neural network model according to an embodiment of the present disclosure.

FIG. 2 illustrates an exemplary structure of an artificial intelligence-based model according to an embodiment of the present disclosure.

FIG. 3 is a flowchart illustrating a process of deploying a neural network model according to an embodiment of the present disclosure.

FIG. 4 is a conceptual diagram illustrating a process of generating a plurality of hardware optimized models using a plurality of conversion sub-modules according to an embodiment of the present disclosure.

FIG. 5 is a conceptual diagram illustrating a process of generating a plurality of first target hardware optimized sub-models based on a first conversion sub-module according to an embodiment of the present disclosure.

FIG. 6 is a simplified and general schematic diagram of an exemplary computing environment in which embodiments of the present disclosure may be implemented.

### DETAILED DESCRIPTION

The present disclosure discloses an automated method for converting a general-purpose neural network model into a dedicated model optimized for each of a plurality of target hardware using a conversion module including a plurality of conversion sub-modules.

Various embodiments are now described with reference to the drawings. In the present specification, various descriptions are presented to provide an understanding of the present disclosure. However, it is apparent that these embodiments may be practiced without these specific details.

Terms such as “component,” “module,” “system,” and the like used in the present specification refer to a computer-related entity, hardware, firmware, software, a combination of software and hardware, or execution of software. For example, a component may be, but is not limited to, a procedure running on a processor, a processor, an object, an executable thread, a program, and/or a computer. For example, both an application running on a computing device and the computing device may be components. One or more components may reside within a processor and/or an executable thread. One component may be localized within one computer. In the present disclosure, one or more components may be distributed between two or more computers, i.e., execution environments. In addition, these components may execute from various computer-readable media having various data structures stored therein. Components may communicate via local and/or remote processes according to a signal having one or more data packets (e.g., data from one component interacting with another component in a local system or distributed system and/or signals transmitted over a network such as the Internet to other systems).

In addition, the term “or” is intended to mean an inclusive “or” rather than an exclusive “or.” That is, unless specified otherwise or clear from the context, “X uses A or B” is intended to mean any of the natural inclusive permutations. That is, if X uses A; X uses B; or X uses both A and B, then “X uses A or B” applies to any of these instances. Furthermore, the term “and/or” used in the present specification should be understood to refer to and include all possible combinations of one or more of the listed related items.

Also, the terms “comprises” and/or “comprising” should be understood to mean that the corresponding feature and/or element exists. However, the terms “comprises” and/or “comprising” should be understood not to exclude the presence or addition of one or more other features, elements, and/or groups thereof. In addition, unless specified otherwise or clear from the context to indicate a singular form, the singular forms in the present specification and claims should generally be construed to mean “one or more.”

And, the term “at least one of A or B” should be interpreted to mean “a case including only A,” “a case including only B,” or “a case combined with the configuration of A and B.”

Those skilled in the art should recognize that the various exemplary logical blocks, configurations, modules, circuits, means, logic, and algorithm steps described in connection with the embodiments disclosed herein may be implemented as electronic hardware, computer software, or combinations of both. To clearly illustrate this interchangeability of hardware and software, various exemplary components, blocks, configurations, means, logic, modules, circuits, and steps have been described above generally in terms of their functionality. Whether such functionality is implemented as hardware or software depends upon the particular application and design constraints imposed on the overall system. Skilled artisans may implement the described functionality in various ways for each particular application, but such implementation decisions should not be interpreted as causing a departure from the scope of the present disclosure.

The description of the presented embodiments is provided to enable any person skilled in the art to make or use the present disclosure. Various modifications to these embodiments will be apparent to those skilled in the art, and the general principles defined herein may be applied to other embodiments without departing from the scope of the present disclosure. Thus, the present disclosure is not intended to be limited to the embodiments shown herein. The present disclosure is to be accorded the widest scope consistent with the principles and novel features presented herein.

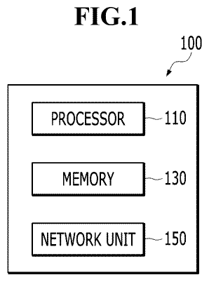

FIG. 1 is a block diagram of a computing device for converting a neural network model according to an embodiment of the present disclosure.

The configuration of the computing device 100 shown in FIG. 1 is merely a simplified example. In an embodiment of the present disclosure, the computing device 100 may include other components for performing the computing environment of the computing device 100, and only some of the disclosed components may constitute the computing device 100.

The computing device 100 may include a processor 110, a memory 130, and a network unit 150.

The processor 110 may consist of one or more cores and may include a processor for data analysis and deep learning, such as a central processing unit (CPU), a general purpose graphics processing unit (GPGPU), or a tensor processing unit (TPU) of the computing device. The processor 110 may read a computer program stored in the memory 130 to perform data processing for machine learning according to an embodiment of the present disclosure. According to an embodiment of the present disclosure, the processor 110 may perform operations for learning of a neural network. The processor 110 may perform calculations for learning of a neural network, such as processing input data for learning in deep learning (DL), extracting features from input data, calculating errors, and updating weights of the neural network using backpropagation.

At least one of the CPU, GPGPU, and TPU of the processor 110 may process the learning of a network function. For example, the CPU and GPGPU may process the learning of the network function and data classification using the network function together. In addition, in an embodiment of the present disclosure, processors of a plurality of computing devices may be used together to process the learning of the network function and data classification using the network function. Furthermore, the computer program executed in the computing device according to an embodiment of the present disclosure may be a CPU, GPGPU, or TPU executable program.

In the present disclosure, the processor 110 may identify a conversion target neural network model. In the present disclosure, the conversion target neural network model may be received from outside the computing device 100, or a neural network model stored in the memory 130 of one computing device 100 may be identified for conversion, but the present disclosure is not limited to the above embodiment. In the present disclosure, the conversion target neural network model may be a model generated using a general-purpose framework. Specifically, the conversion target neural network model may be a model completed using a framework such as PyTorch.

The processor 110 may generate a plurality of target hardware optimized models based on inputting the conversion target neural network model into a conversion module.

In an embodiment of the present disclosure, the conversion module for generating the plurality of target hardware optimized models may include a plurality of conversion sub-modules. For example, the conversion module may include a first conversion sub-module and a second conversion sub-module.

In this case, each conversion sub-module may include a framework related to inference of a neural network of different hardware. For example, when the conversion module includes the first conversion sub-module and the second conversion sub-module, the first conversion sub-module may include a framework related to inference of a neural network model for using “first target hardware,” which is an NPU included in a System on Chip (SoC) manufactured by Qualcomm, and the second conversion sub-module may include a framework related to inference of a neural network model for using “second target hardware,” which is an NPU included in a System on Chip (SoC) manufactured by Apple. Each framework may be provided in the form of guidelines by a chip manufacturer, or alternatively, a framework related to inference of a neural network model may be separately written by a user or a third party using disclosed specifications.

The processor 110 may generate a first hardware optimized model optimized for the first target hardware based on inputting the conversion target neural network model into the first conversion sub-module included in the conversion module. For example, based on inputting the conversion target neural network model into the first conversion sub-module, the processor 110 may generate a first target hardware optimized model optimized to utilize the NPU included in the SoC manufactured by Qualcomm to the maximum extent.

Before generating the first target hardware optimized model, the processor 110 may generate a general optimized model based on inputting the conversion target neural network model into a pre-processing module. At this time, the general optimization module may be a module including a model optimization routine commonly applicable to models written in general-purpose frameworks. Instead of directly converting the conversion target neural network model into the target hardware optimized model, the processor 110 may generate the target hardware optimized model based on the general optimized model.

In the present disclosure, the general optimization module may be a module that performs processes such as delete unsupported operator, delete dynamic shape operator, fix tensor shapes, and ONNX model optimizations (graph simplification, operators optimizations) on the input neural network model.

Meanwhile, based on inputting the conversion target neural network model into the second conversion sub-module, the processor 110 may generate a second target hardware optimized model optimized to utilize the NPU included in the SoC manufactured by Apple to the maximum extent.

In the present disclosure, each of the conversion sub-modules may include a framework that is continuously updated according to updated guidelines of the manufacturer of the target hardware.

Meanwhile, in the process of generating the first target hardware optimized model, the processor 110 may generate a plurality of first target hardware optimized sub-models based on a predetermined parameter set. In the present disclosure, the parameter set may include parameters for processing one base model according to a purpose. For example, the parameter set may include a parameter related to a type of the target hardware or a parameter related to quantization of the neural network model. Specifically, when the first target hardware is hardware manufactured by Qualcomm, the parameter related to the type of the target hardware may include parameters such as ‘CPU’ or ‘NPU’ which are types of hardware on which the target hardware optimized model will run, and the parameter related to quantization of the neural network model may include parameters such as ‘FP32 (32-bit floating point operation)’, ‘FP16 (16-bit floating point operation)’, and ‘INT8 (8-bit integer operation)’. In this case, the processor 110 may generate models with a combination of a plurality of parameters, such as ‘a model with relatively high speed but low quality of generation (NPU, INT8)’, ‘a model with a balance between speed and quality of generation (NPU, FP16)’, and ‘a model with relatively low speed but high quality of generation (CPU, FP32)’ for one base model.

The processor 110 may generate a plurality of first target hardware optimized sub-models based on one conversion target neural network model. For example, when the first target hardware is hardware manufactured by Qualcomm, the processor 110 may generate a neural network model of FP32 format using CPU as a first target hardware optimized first sub-model, a neural network model of FP16 format using NPU as a first target hardware optimized second sub-model, a neural network model of INT8 format using NPU as a first target hardware optimized third sub-model, and the like. In this case, after converting a plurality of models in advance according to various demands of users, a suitable model may be deployed according to a user's request.

The processor 110 may receive information related to a deployment request for a neural network model from an edge device. At this time, the information related to the deployment request may include information related to hardware of a user using the edge device and information related to characteristics of the neural network model input by the user. For example, the information related to the hardware of the user using the edge device may be information related to a type of an NPU included in a mobile SoC mounted on a smartphone (edge device). In addition, the information related to characteristics of the neural network model may be information including characteristics of a desired neural network model determined when the user transmits the deployment request. For example, the characteristics of the neural network model may include characteristics such as ‘priority on speed’, ‘balanced’, and ‘priority on quality’, and the user may select a characteristic of the neural network model to be deployed as ‘priority on quality’. In this case, the information related to the deployment request may include information related to ‘priority on quality’.

The processor 110 may deploy a target hardware optimized model corresponding to the information related to the deployment request to the edge device. For example, when the information related to the deployment request includes information that “the hardware of the user's edge device is an NPU manufactured by Qualcomm” and “the user selected a ‘priority on quality’ type neural network model”, the processor 110 may deploy a relatively large-scale model with high quality of output among models optimized for Qualcomm's hardware among various target hardware specialized neural network models currently existing in a model library to the user's edge device. As another example, the information related to the deployment request may include information on a manufacturer and a code number of hardware mounted on the edge device, and the processor 110 may automatically select and deploy the most appropriate neural network model among models optimized for the corresponding hardware even without a separate request from the user.

Meanwhile, if a target hardware optimized model corresponding to the hardware of the user does not exist, the processor 110 may deploy a general optimized model to the edge device.

Through the method of the present disclosure, a developer of a neural network model or a developer of a service utilizing a neural network model can prepare a plurality of specialized models converted to be optimized for each hardware in advance, without separately converting the model or service one by one according to guidelines of each hardware manufacturer. Thereafter, when a user requests deployment of a model or service, a neural network model optimized for specialized hardware mounted on an edge device being used by the user can be immediately deployed.

In the present disclosure, the processor 110 may generate a user interface for using the conversion module in a development environment. In this case, the user interface may include a first area for displaying a key of the conversion target neural network model and a second area for displaying a type of the development environment. Through the simplified user interface, a developer in the field of artificial intelligence can create target hardware optimized models converted so that neural network models written in general-purpose frameworks can be easily used in each hardware.

According to an embodiment of the present disclosure, the memory 130 may include a storage medium of at least one type among a flash memory type, a hard disk type, a multimedia card micro type, a card type memory (e.g., SD or XD memory, etc.), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk. The computing device 100 may operate in association with a web storage performing a storage function of the memory 130 on the Internet. The description of the memory described above is merely an example, and the present disclosure is not limited thereto.

The network unit 150 according to an embodiment of the present disclosure may use various wired communication systems such as a Public Switched Telephone Network (PSTN), x Digital Subscriber Line (xDSL), Rate Adaptive DSL (RADSL), Multi Rate DSL (MDSL), Very High Speed DSL (VDSL), Universal Asymmetric DSL (UADSL), High Bit Rate DSL (HDSL), and a Local Area Network (LAN).

In addition, the network unit 150 presented herein may use various wireless communication systems such as Code Division Multi Access (CDMA), Time Division Multi Access (TDMA), Frequency Division Multi Access (FDMA), Orthogonal Frequency Division Multi Access (OFDMA), Single Carrier-FDMA (SC-FDMA), and other systems.

In the present disclosure, the network unit 150 may use any form of wired or wireless communication system.

The techniques described herein may be used in other networks as well as the networks mentioned above.

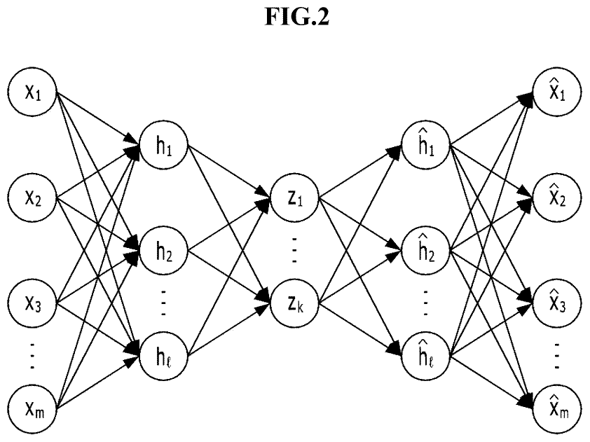

FIG. 2 illustrates an exemplary structure of an artificial intelligence-based model according to an embodiment of the present disclosure.

Throughout the present specification, an artificial intelligence model, an artificial intelligence-based model, a computational model, a neural network, a network function, and a neural network may be used interchangeably.

A neural network may generally be composed of a set of interconnected computational units, which may be referred to as nodes. These nodes may also be referred to as neurons. A neural network is configured to include at least one or more nodes. Nodes (or neurons) constituting neural networks may be interconnected by one or more links.

Within a neural network, one or more nodes connected via links may form a relationship of an input node and an output node relatively. The concepts of input node and output node are relative, and an arbitrary node in an output node relationship with respect to one node may be in an input node relationship in a relationship with another node, and vice versa. As described above, an input node to output node relationship may be generated around a link. One or more output nodes may be connected to one input node via a link, and vice versa.

In a relationship of an input node and an output node connected via one link, data of the output node may have its value determined based on data input to the input node. Here, the link interconnecting the input node and the output node may have a weight. The weight may be variable and may be varied by a user or an algorithm for the neural network to perform a desired function. For example, when one or more input nodes are interconnected to one output node by respective links, the output node may determine an output node value based on values input to the input nodes connected to the output node and weights set for the links corresponding to the respective input nodes.

As described above, in a neural network, one or more nodes are interconnected via one or more links to form an input node and output node relationship within the neural network. Characteristics of the neural network may be determined according to the number of nodes and links within the neural network, correlations between nodes and links, and values of weights assigned to each of the links. For example, if there are two neural networks having the same number of nodes and links but different weight values of the links, the two neural networks may be recognized as being different from each other.

A neural network may be composed of a set of one or more nodes. A subset of nodes constituting a neural network may constitute a layer. Some of the nodes constituting the neural network may constitute one layer based on distances from an initial input node. For example, a set of nodes having a distance of n from the initial input node may constitute an n layer. The distance from the initial input node may be defined by the minimum number of links that must be traversed to reach the corresponding node from the initial input node. However, this definition of a layer is arbitrary for explanation, and the order of a layer within a neural network may be defined in a method different from that described above. For example, layers of nodes may be defined by distances from a final output node.

In an embodiment of the present disclosure, a set of neurons or nodes may be defined by the expression “layer.”

The initial input node may refer to one or more nodes to which data is directly input without passing through a link in a relationship with other nodes among nodes in the neural network. Alternatively, it may refer to nodes that do not have other input nodes connected by links in a relationship between nodes based on links within the neural network network. Similarly, the final output node may refer to one or more nodes that do not have an output node in a relationship with other nodes among nodes in the neural network. Also, hidden nodes may refer to nodes constituting the neural network other than the initial input node and the final output node.

In a neural network according to an embodiment of the present disclosure, the number of nodes in an input layer may be equal to the number of nodes in an output layer, and the number of nodes may decrease and then increase again as it progresses from the input layer to a hidden layer. Also, in a neural network according to another embodiment of the present disclosure, the number of nodes in an input layer may be smaller than the number of nodes in an output layer, and the number of nodes may decrease as it progresses from the input layer to a hidden layer. Also, in a neural network according to another embodiment of the present disclosure, the number of nodes in an input layer may be larger than the number of nodes in an output layer, and the number of nodes may increase as it progresses from the input layer to a hidden layer. A neural network according to another embodiment of the present disclosure may be a combined form of the above-described neural networks.

An artificial intelligence-based model according to an embodiment of the present disclosure may include a Deep Neural Network (DNN). The deep neural network may refer to a neural network including a plurality of hidden layers in addition to an input layer and an output layer. Using a deep neural network, latent structures of data can be identified. That is, latent structures of photos, text, video, voice, protein sequence structures, gene sequence structures, peptide sequence structures, and music (e.g., what object is in a photo, what the content and emotion of text are, what the content and emotion of voice are, etc.), and/or binding affinity between peptide and MHC can be identified. The deep neural network may include a Convolutional Neural Network (CNN), a Recurrent Neural Network (RNN), an Autoencoder (AE), a Variational Autoencoder (VAE), a Restricted Boltzmann Machine (RBM), a Deep Belief Network (DBN), a Q network, a U network, a Siamese network, a Generative Adversarial Network (GAN), a Transformer, and the like. The description of the deep neural network described above is merely an example, and the present disclosure is not limited thereto.

The artificial intelligence-based model of the present disclosure may be represented by a network structure of any of the structures described above including an input layer, a hidden layer, and an output layer.

A neural network that may be used in the artificial intelligence-based model of the present disclosure may be learned by at least one method of supervised learning, unsupervised learning, semi-supervised learning, transfer learning, active learning, or reinforcement learning. Learning of the neural network may be a process of applying knowledge for the neural network to perform a specific operation to the neural network.

The neural network may be learned in a direction to minimize an error of an output. In learning of the neural network, learning data is repeatedly input to the neural network, an error between an output of the neural network for the learning data and a target is calculated, and the error of the neural network is backpropagated from an output layer to an input layer of the neural network in a direction to reduce the error to update a weight of each node of the neural network. In the case of supervised learning, learning data labeled with a correct answer is used for each learning data (i.e., labeled learning data), and in the case of unsupervised learning, a correct answer may not be labeled for each learning data. That is, for example, learning data in the case of supervised learning regarding data classification may be data in which a category is labeled for each learning data. Labeled learning data is input to the neural network, and an error may be calculated by comparing an output (category) of the neural network with the label of the learning data. As another example, in the case of unsupervised learning regarding data classification, an error may be calculated by comparing learning data, which is an input, with a neural network output. The calculated error is backpropagated in a reverse direction (i.e., from the output layer to the input layer) in the neural network, and connection weights of each node of each layer of the neural network may be updated according to backpropagation. The amount of change of the updated connection weight of each node may be determined according to a learning rate. Calculation of the neural network for input data and backpropagation of the error may constitute a learning cycle (epoch). The learning rate may be applied differently according to the number of repetitions of the learning cycle of the neural network. For example, in the early stage of learning of the neural network, a high learning rate may be used to allow the neural network to quickly secure a certain level of performance to increase efficiency, and in the late stage of learning, a low learning rate may be used to increase accuracy.

Generally, in learning of a neural network, learning data may be a subset of actual data (i.e., data to be processed using a learned neural network), and thus, a learning cycle in which an error for the learning data decreases but an error for the actual data increases may exist. Overfitting is a phenomenon in which an error for actual data increases due to excessive learning on learning data in this way. For example, a phenomenon in which a neural network that has learned a cat by showing a yellow cat fails to recognize a cat when seeing a cat other than yellow may be a kind of overfitting. Overfitting may act as a cause of increasing errors in machine learning algorithms. Various optimization methods may be used to prevent such overfitting. To prevent overfitting, methods such as increasing learning data, regularization, dropout that deactivates some nodes of the network in the process of learning, and utilization of a batch normalization layer may be applied.

The artificial intelligence model according to an embodiment of the present disclosure may be a generative model. A generative model is a model that learns a distribution of given learning data and generates similar data following the distribution of the learning data. The generative model may include a Variational Autoencoder (VAE), a Generative Adversarial Network (GAN), a Diffusion model, and the like. The Variational Autoencoder (VAE) may refer to a model that learns to approximate density of learning data and reconstruct input data based on the estimated distribution of the learning data. The Generative Adversarial Network (GAN) may refer to a model that learns to generate data without explicitly defining a distribution of learning data. The diffusion model may include a diffusion process of gradually adding noise generated from a fixed normal distribution to data. In addition, the diffusion model can reconstruct data by learning a reverse process of removing noise. That is, the diffusion model may refer to a model that generates a result image having a probability distribution similar to input data by gradually removing noise generated from a learned normal distribution.

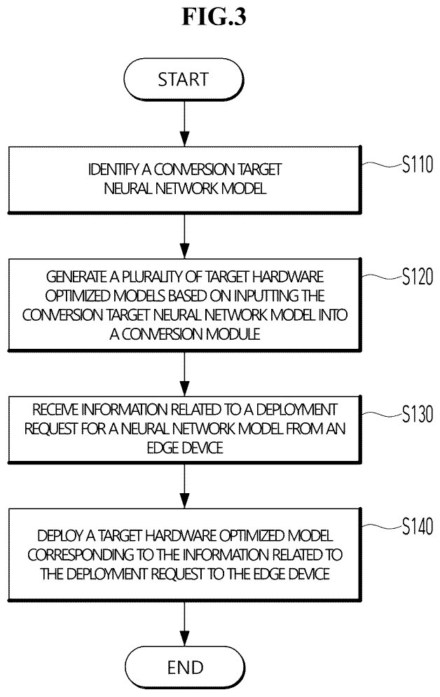

FIG. 3 is a flowchart illustrating a process of deploying a neural network model according to an embodiment of the present disclosure.

According to the present disclosure, the process of deploying a neural network model may include identifying a conversion target neural network model (S110), generating a plurality of target hardware optimized models based on inputting the conversion target neural network model into a conversion module (S120), receiving information related to a deployment request for a neural network model from an edge device (S130), and deploying a target hardware optimized model corresponding to the information related to the deployment request to the edge device (S140).

In step S110, the processor 110 may identify a conversion target neural network model. The detailed process of identifying the conversion target neural network model of the present disclosure has been described above with reference to FIG. 1.

In step S120, the processor 110 may generate a plurality of target hardware optimized models based on inputting the conversion target neural network model into the conversion module. The process in which the processor 110 generates the plurality of target hardware optimized models has been described above with reference to FIG. 1.

In step S130, the processor 110 may receive information related to a deployment request for a neural network model from an edge device. The detailed description of the information related to the deployment request has been described above with reference to FIG. 1.

In step S140, the processor 110 may deploy a target hardware optimized model corresponding to the information related to the deployment request to the edge device. The detailed process in which the processor 110 deploys the target hardware optimized model to the edge device at the user's request has been described above with reference to FIG. 1.

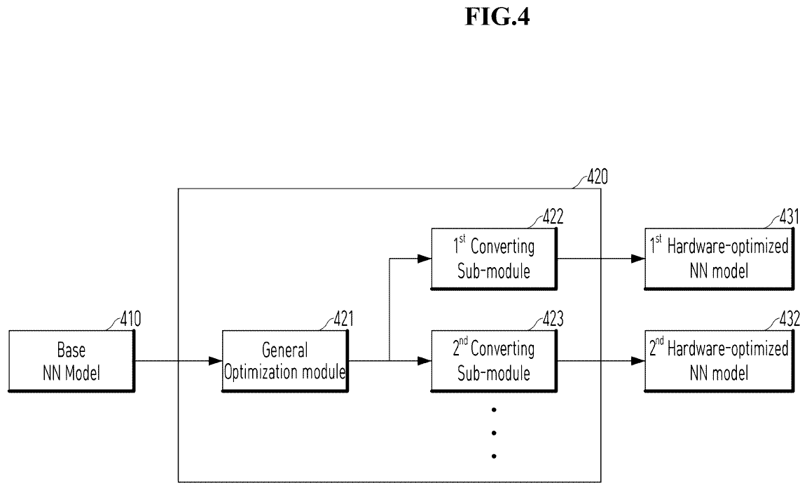

FIG. 4 is a conceptual diagram illustrating a process of generating a plurality of hardware optimized models using a plurality of conversion sub-modules according to an embodiment of the present disclosure.

In the present disclosure, the processor 110 may generate a target hardware optimized model based on inputting a conversion target neural network model 410 into a conversion module 420. The conversion module 420 may selectively include a pre-processing module 421, and the pre-processing module 421 may generate a general optimized model based on the conversion target neural network model 410.

The conversion module 420 may include a first conversion sub-module 422 and a second conversion sub-module 423. Each conversion sub-module may include a framework for running on hardware specialized for inference of a neural network model included in SoCs of different manufacturers.

The processor 110 may generate a first target hardware optimized model 431 based on inputting the conversion target neural network model 410 into the first conversion sub-module 422, and alternatively, generate a second target hardware optimized model 432 based on inputting it into the second conversion sub-module 423.

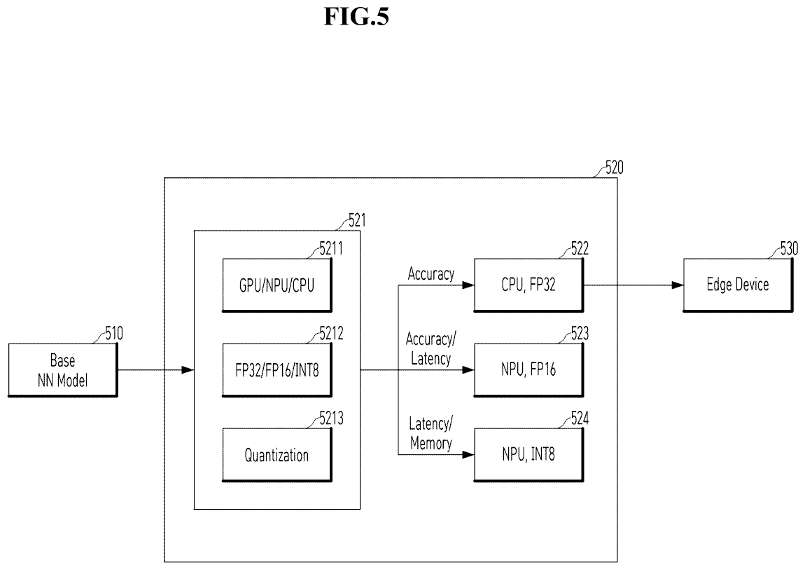

FIG. 5 is a conceptual diagram illustrating a process of generating a plurality of first target hardware optimized sub-models based on a first conversion sub-module according to an embodiment of the present disclosure.

The processor 110 may generate a plurality of first target hardware optimized sub-models based on inputting a conversion target neural network model 510 into a first conversion sub-module 520.

Specifically, the processor 110 may generate the plurality of first target hardware optimized sub-models based on a predetermined parameter set 521. For example, in FIG. 5, the parameter set 521 may include a parameter 5211 related to hardware of a user of an edge device and a parameter 5212 related to characteristics of a neural network model. According to a combination of parameters, the processor 110 may generate a first target hardware optimized first sub-model 522, a first target hardware optimized second sub-model 523, and a first target hardware optimized third sub-model 524.

Thereafter, the processor 110 may deploy an appropriate target hardware optimized sub-model to an edge device 530 according to a user's request. For example, when a user using an edge device equipped with the first target hardware transmits a request desiring a neural network model with relatively slow speed but good quality of a result, the processor 110 may deploy the first target hardware optimized first sub-model 522 to the edge device 530.

Meanwhile, according to an embodiment of the present disclosure, a computer-readable medium storing a data structure is disclosed.

A data structure may refer to organization, management, and storage of data enabling efficient access and modification of data. The data structure may refer to organization of data for solving a specific problem (e.g., data search, data storage, data modification in the shortest time). The data structure may also be defined by physical or logical relationships between data elements designed to support specific data processing functions. Logical relationships between data elements may include connection relationships between user-defined data elements. Physical relationships between data elements may include actual relationships between data elements physically stored in a computer-readable storage medium (e.g., permanent storage device). The data structure may specifically include a set of data, relationships between data, and functions or commands applicable to data. Through an effectively designed data structure, a computing device can perform calculations while minimally using resources of the computing device. Specifically, the computing device can increase efficiency of calculation, reading, insertion, deletion, comparison, exchange, and search through an effectively designed data structure.

Data structures may be classified into linear data structures and non-linear data structures according to the form of the data structure. A linear data structure may be a structure in which only one datum is connected after one datum. The linear data structure may include a List, a Stack, a Queue, and a Deque. A list may refer to a set of data in which an order exists internally. The list may include a Linked List. The linked list may be a data structure in which data is connected in a way that each datum has a pointer and is connected in a line. In the linked list, the pointer may include connection information with next or previous data. The linked list may be expressed as a single linked list, a double linked list, or a circular linked list according to a form. A stack may be a data listing structure in which data can be accessed limitedly. The stack may be a linear data structure in which data can be processed (e.g., insertion or deletion) only at one end of the data structure. Data stored in the stack may be a data structure in which data entered later comes out sooner (LIFO—Last In First Out). A queue is a data listing structure in which data can be accessed limitedly, and unlike the stack, may be a data structure in which data stored later comes out later (FIFO—First In First Out). A deque may be a data structure in which data can be processed at both ends of the data structure.

A non-linear data structure may be a structure in which a plurality of data are connected after one datum. The non-linear data structure may include a Graph data structure. The graph data structure may be defined by Vertices and Edges, and an edge may include a line connecting two different vertices. The graph data structure may include a Tree data structure. The tree data structure may be a data structure in which a path connecting two different vertices among a plurality of vertices included in a tree is one. That is, it may be a data structure that does not form a loop in the graph data structure.

Throughout the present specification, a computational model, a neural network, a network function, and a neural network may be used interchangeably. Hereinafter, it is uniformly described as a neural network. A data structure may include a neural network. And the data structure including the neural network may be stored in a computer-readable medium. The data structure including the neural network may also include data pre-processed for processing by the neural network, data input to the neural network, weights of the neural network, hyper-parameters of the neural network, data obtained from the neural network, an activation function associated with each node or layer of the neural network, a loss function for learning of the neural network, and the like. The data structure including the neural network may include any components among the disclosed configurations. That is, the data structure including the neural network may be configured to include all of data pre-processed for processing by the neural network, data input to the neural network, weights of the neural network, hyper-parameters of the neural network, data obtained from the neural network, an activation function associated with each node or layer of the neural network, a loss function for learning of the neural network, etc., or any combination thereof. In addition to the configurations described above, the data structure including the neural network may include any other information determining characteristics of the neural network. Also, the data structure may include all types of data used or generated in a calculation process of the neural network and is not limited to the matters described above. The computer-readable medium may include a computer-readable recording medium and/or a computer-readable transmission medium. A neural network may generally be composed of a set of interconnected computational units, which may be referred to as nodes. These nodes may also be referred to as neurons. A neural network is configured to include at least one or more nodes.

The data structure may include data input to a neural network. The data structure including data input to the neural network may be stored in a computer-readable medium. Data input to the neural network may include learning data input in a neural network learning process and/or input data input to a neural network whose learning is completed. Data input to the neural network may include data that has undergone pre-processing and/or data that is a target of pre-processing. Pre-processing may include a data processing process for inputting data into the neural network. Therefore, the data structure may include data that is a target of pre-processing and data generated by pre-processing. The data structure described above is merely an example, and the present disclosure is not limited thereto.

The data structure may include weights of a neural network. (In the present specification, weights and parameters may be used interchangeably.) And the data structure including weights of the neural network may be stored in a computer-readable medium. The neural network may include a plurality of weights. Weights may be variable and may be varied by a user or an algorithm for the neural network to perform a desired function. For example, when one or more input nodes are interconnected to one output node by respective links, the output node may determine a data value output from the output node based on values input to the input nodes connected to the output node and weights set for the links corresponding to the respective input nodes. The data structure described above is merely an example, and the present disclosure is not limited thereto.

As a non-limiting example, weights may include weights varied in a neural network learning process and/or weights for which neural network learning is completed. Weights varied in the neural network learning process may include weights at a time point when a learning cycle starts and/or weights varied during a learning cycle. Weights for which neural network learning is completed may include weights for which a learning cycle is completed. Therefore, the data structure including weights of the neural network may include a data structure including weights varied in a neural network learning process and/or weights for which neural network learning is completed. Therefore, the above-described weights and/or combinations of each weight are assumed to be included in the data structure including weights of the neural network. The data structure described above is merely an example, and the present disclosure is not limited thereto.

The data structure including weights of the neural network may be stored in a computer-readable storage medium (e.g., memory, hard disk) after undergoing a serialization process. Serialization may be a process of converting a data structure into a form that can be stored in the same or another computing device and later reconstructed and used. The computing device may serialize the data structure to transmit and receive data over a network. The serialized data structure including weights of the neural network may be reconstructed in the same computing device or another computing device through deserialization. The data structure including weights of the neural network is not limited to serialization. Furthermore, the data structure including weights of the neural network may include a data structure for increasing efficiency of calculation while minimally using resources of the computing device (e.g., B-Tree, Trie, m-way search tree, AVL tree, Red-Black Tree in non-linear data structures). The matters described above are merely examples, and the present disclosure is not limited thereto.

The data structure may include hyper-parameters of a neural network. And the data structure including hyper-parameters of the neural network may be stored in a computer-readable medium. Hyper-parameters may be variables varied by a user. Hyper-parameters may include, for example, a learning rate, a cost function, the number of learning cycle repetitions, weight initialization (e.g., setting a range of weight values that are targets of weight initialization), and the number of Hidden Units (e.g., the number of hidden layers, the number of nodes in a hidden layer). The data structure described above is merely an example, and the present disclosure is not limited thereto.

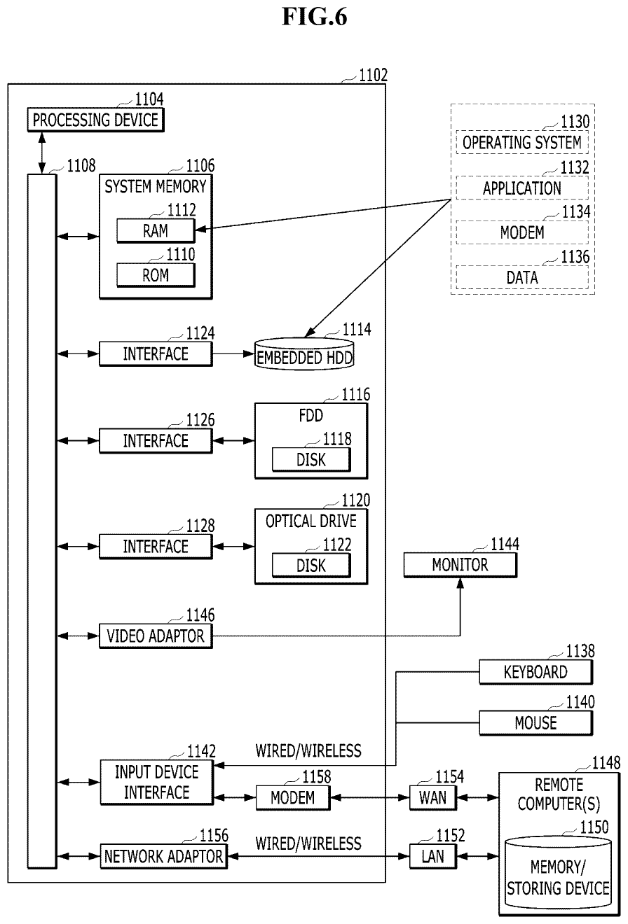

FIG. 6 is a simplified and general schematic diagram of an exemplary computing environment in which embodiments of the present disclosure may be implemented.

Although the present disclosure has generally been described above as being implementable by a computing device, those skilled in the art will well appreciate that the present disclosure may be implemented in combination with computer-executable instructions and/or other program modules that can be executed on one or more computers and/or as a combination of hardware and software.

Generally, program modules include routines, programs, components, data structures, etc. that perform particular tasks or implement particular abstract data types. Also, those skilled in the art will well appreciate that the method of the present disclosure may be practiced with other computer system configurations, including single-processor or multiprocessor computer systems, minicomputers, mainframe computers, as well as personal computers, handheld computing devices, microprocessor-based or programmable consumer electronics, etc. (each of which may operate in connection with one or more associated devices).

The described embodiments of the present disclosure may also be practiced in distributed computing environments where certain tasks are performed by remote processing devices that are linked through a communications network. In a distributed computing environment, program modules may be located in both local and remote memory storage devices.

A computer typically includes various computer-readable media. Any medium accessible by a computer can be a computer-readable medium, and such computer-readable media include volatile and non-volatile media, transitory and non-transitory media, and removable and non-removable media. As a non-limiting example, computer-readable media may include computer-readable storage media and computer-readable transmission media. Computer-readable storage media include volatile and non-volatile media, transitory and non-transitory media, and removable and non-removable media implemented in any method or technology for storage of information such as computer-readable instructions, data structures, program modules, or other data. Computer-readable storage media include, but are not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be accessed by a computer and used to store desired information.

Computer-readable transmission media typically implement computer-readable instructions, data structures, program modules, or other data in a modulated data signal such as a carrier wave or other transport mechanism, and include all information delivery media. The term modulated data signal means a signal that has one or more of its characteristics set or changed in such a manner as to encode information in the signal. As a non-limiting example, computer-readable transmission media include wired media such as a wired network or direct-wired connection, and wireless media such as acoustic, RF, infrared, and other wireless media. Combinations of any of the above are also intended to be included within the scope of computer-readable transmission media.

An exemplary environment for implementing various aspects of the present disclosure including a computer 1102 is shown, wherein the computer 1102 includes a processing unit 1104, a system memory 1106, and a system bus 1108. The system bus 1108 couples system components including, but not limited to, the system memory 1106 to the processing unit 1104. The processing unit 1104 can be any of various commercially available processors. Dual microprocessors and other multiprocessor architectures may also be employed as the processing unit 1104.

The system bus 1108 can be any of several types of bus structures that may further interconnect to a memory bus, a peripheral bus, and a local bus using any of a variety of commercially available bus architectures. The system memory 1106 includes read-only memory (ROM) 1110 and random access memory (RAM) 1112. A basic input/output system (BIOS) is stored in non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 also includes an internal hard disk drive (HDD) 1114 (e.g., EIDE, SATA)—this internal hard disk drive 1114 may also be configured for external use in a suitable chassis (not shown)—, a magnetic floppy disk drive (FDD) 1116 (e.g., to read from or write to a removable diskette 1118), and an optical disk drive 1120 (e.g., reading a CD-ROM disk 1122 or to read from or write to other high capacity optical media such as the DVD). The hard disk drive 1114, magnetic disk drive 1116, and optical disk drive 1120 can be connected to the system bus 1108 by a hard disk drive interface 1124, a magnetic disk drive interface 1126, and an optical drive interface 1128, respectively. The interface 1124 for external drive implementations includes at least one or both of Universal Serial Bus (USB) and IEEE 1394 interface technologies.

These drives and their associated computer-readable media provide nonvolatile storage of data, data structures, computer-executable instructions, and so forth. For the computer 1102, the drives and media correspond to the storage of any data in a suitable digital format. Although the description of computer-readable media above refers to a HDD, a removable magnetic disk, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the present disclosure.

A number of program modules can be stored in the drives and RAM 1112, including an operating system 1130, one or more application programs 1132, other program modules 1134, and program data 1136. All or portions of the operating system, applications, modules, and/or data can also be cached in the RAM 1112. It is appreciated that the present disclosure can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, a touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adapter 1156 may facilitate wired or wireless communication to the LAN 1152, which may also include a wireless access point installed thereon for communicating with the wireless adapter 1156. When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant (PDA), communications satellite, any piece of equipment or location associated with a wirelessly detectable tag, and a telephone. This includes at least Wi-Fi and Bluetooth wireless technologies. Thus, the communication can be a predefined structure as with a conventional network or simply an ad hoc communication between at least two devices.

Wi-Fi (Wireless Fidelity) allows connection to the Internet etc. without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band).

Those skilled in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various exemplary logical blocks, modules, processors, means, circuits, and algorithm steps described in connection with the embodiments disclosed herein may be implemented by electronic hardware, various forms of program or design code (referred to herein as software for convenience), or combinations of both. To clearly illustrate this interchangeability of hardware and software, various exemplary components, blocks, modules, circuits, and steps have been described above generally in terms of their functionality. Whether such functionality is implemented as hardware or software depends upon the particular application and design constraints imposed on the overall system. Skilled artisans may implement the described functionality in various ways for each particular application, but such implementation decisions should not be interpreted as causing a departure from the scope of the present disclosure.

Various embodiments presented herein may be implemented as a method, apparatus, or article of manufacture using standard programming and/or engineering techniques. The term article of manufacture includes a computer program, carrier, or media accessible from any computer-readable storage device. For example, computer-readable storage media include, but are not limited to, magnetic storage devices (e.g., hard disk, floppy disk, magnetic strips, etc.), optical disks (e.g., CD, DVD, etc.), smart cards, and flash memory devices (e.g., EEPROM, card, stick, key drive, etc.). Also, various storage media presented herein include one or more devices and/or other machine-readable media for storing information.

It is to be understood that the specific order or hierarchy of steps in the processes presented is an example of exemplary approaches. Based on design priorities, it is understood that the specific order or hierarchy of steps in the processes may be rearranged within the scope of the present disclosure. The accompanying method claims present elements of the various steps in a sample order, and are not meant to be limited to the specific order or hierarchy presented.

The description of the presented embodiments is provided to enable any person skilled in the art to make or use the present disclosure. Various modifications to these embodiments will be apparent to those skilled in the art, and the general principles defined herein may be applied to other embodiments without departing from the scope of the present disclosure. Thus, the present disclosure is not intended to be limited to the embodiments shown herein. The present disclosure is to be accorded the widest scope consistent with the principles and novel features presented herein.

1. A method performed by a computing device for converting a neural network model, the method comprising:
identifying a conversion target neural network model;
generating a plurality of target hardware optimized models based on inputting the conversion target neural network model into a conversion module;
configuring a model library based on the plurality of target hardware optimized models;
receiving information related to a deployment request for a neural network model from an edge device;
determining a target hardware optimized model among models included in the model library based on the information related to the deployment request; and
deploying the determined target hardware optimized model to the edge device,
wherein the conversion module includes a first conversion sub-module corresponding to a first target hardware and a second conversion sub-module corresponding to a second target hardware,
wherein the first conversion sub-module includes a framework related to inference of a neural network of the first target hardware,
wherein the second conversion sub-module includes a framework related to inference of a neural network of the second target hardware, and
wherein the frameworks related to inference of the neural network of the target hardware are continuously updated in accordance with changes in guidelines for each of the corresponding target hardware.

2. The method of claim 1, wherein the generating of the plurality of target hardware optimized models based on inputting the conversion target neural network model into the conversion module includes:
generating a general optimized model based on inputting the conversion target neural network model into a pre-processing module;
generating a first target hardware optimized model based on inputting the general optimized model into the first conversion sub-module; and
generating a second target hardware optimized model based on inputting the general optimized model into the second conversion sub-module.

3. The method of claim 2,
wherein the first target hardware optimized model includes a plurality of first target hardware optimized sub-models, and
wherein the generating of the first target hardware optimized model based on inputting the general optimized model into the first conversion sub-module includes:
generating the plurality of first target hardware optimized sub-models based on a predetermined parameter set.

4. The method of claim 3, wherein the predetermined parameter set includes at least one of:
a parameter related to a type of the target hardware; or
a parameter related to quantization of the neural network model.

6. The method of claim 1, wherein the information related to the deployment request includes:
information related to hardware of a user of the edge device; and
information related to a characteristic of the neural network model input by the user.

7. The method of claim 6, further comprising:
after the deploying of the target hardware optimized model corresponding to the information related to the deployment request to the edge device,
deploying a general optimized model to the edge device if a target hardware optimized model corresponding to the hardware of the user does not exist.

8. The method of claim 1, further comprising:
generating a user interface for using the conversion module in a development environment,
wherein the user interface includes:
a first area for displaying a key of the conversion target neural network model; and
a second area for displaying a type of the development environment.

9. A computer program stored in a non-transitory computer-readable storage medium, the computer program causing a computing device to perform operations for converting a neural network model, the operations comprising:
identifying a conversion target neural network model;
generating a plurality of target hardware optimized models based on inputting the conversion target neural network model into a conversion module;
configuring a model library based on the plurality of target hardware optimized models;
receiving information related to a deployment request for a neural network model from an edge device;
determining a target hardware optimized model among models included in the model library based on the information related to the deployment request; and
deploying the determined target hardware optimized model to the edge device,
wherein the conversion module includes a first conversion sub-module corresponding to a first target hardware and a second conversion sub-module corresponding to a second target hardware,
wherein the first conversion sub-module includes a framework related to inference of a neural network of the first target hardware,
wherein the second conversion sub-module includes a framework related to inference of a neural network of the second target hardware, and
wherein the frameworks related to inference of the neural network of the target hardware are continuously updated in accordance with changes in guidelines for each of the corresponding target hardware.

10. A computing device for converting a neural network model, the computing device comprising:
one or more processors; and
a memory,
wherein the one or more processors are configured to:
identify a conversion target neural network model;
generate a plurality of target hardware optimized models based on inputting the conversion target neural network model into a conversion module;
configure a model library based on the plurality of target hardware optimized models;
receive information related to a deployment request for a neural network model from an edge device;
determine a target hardware optimized model among models included in the model library based on the information related to the deployment request; and
deploy the determined target hardware optimized model to the edge device,
wherein the conversion module includes a first conversion sub-module corresponding to a first target hardware and a second conversion sub-module corresponding to a second target hardware,
wherein the first conversion sub-module includes a framework related to inference of a neural network of the first target hardware,
wherein the second conversion sub-module includes a framework related to inference of a neural network of the second target hardware, and
wherein the frameworks related to inference of the neural network of the target hardware are continuously updated in accordance with changes in guidelines for each of the corresponding target hardware.
